(19) United States
(12) Patent Application Publication
(10) Pub. No.: US 2014/0040779 A1
(43) Pub. Date: Feb. 6, 2014

(54) NETWORK BASED CROWD SOURCED COLLABORATION TOOLS FOR THE DEVELOPMENT OF CREATIVE WORKS

(71) Applicant: TIMOTHY JOHN BORTREE, RANCHO SANTA FE, CA (US)

(72) Inventor: TIMOTHY JOHN BORTREE, RANCHO SANTA FE, CA (US)

(21) Appl. No.: 13/958,573

(22) Filed: Aug. 4, 2013

Related U.S. Application Data
(60) Provisional application No. 61/679,760, filed on Aug. 5, 2012.
(60) Provisional application No. 61/856,056, filed on Jul. 19, 2013.

(51) Int. Cl. H04L 29/06

(52) U.S. Cl. CPC H04L 65/403
USPC 715/753

(57) ABSTRACT

Systems and methods are provided for creative collaboration among multiple persons, such as network-based crowd-sourced collaboration tools for the development of creative works. Users are able to post content with specific reference to previously posted content. Content postings that are related to one another based on such specific references are organized in accordance with such specific reference relationships to establish a tree-like content structure in which the initial content posting is like the trunk of the tree-like structure, and later content postings are like branches of the tree-like structure. Included are features for encouraging collaboration, such as: (1) features designed to prevent a single author and/or a limited number of authors from generating all of the content of a creative work, and/or (2) features designed to enable the development of multiple creative works that are related to one another in that they share one or more common content bases.

### CROSS REFERENCE TO RELATED APPLICATIONS

The present application claims priority from U.S. Provisional Application No. 61/679,760 filed Aug. 5, 2012 and U.S. Provisional Application No. 61/856,056 filed Jul. 19, 2013, the entire disclosures of which are hereby incorporated by reference herein.

### FIELD OF THE INVENTION

The present invention generally provides systems and methods for creative collaboration among multiple persons, and specifically provides network-based crowd-sourced collaboration tools for the development of creative works.

### BACKGROUND OF THE INVENTION

Existing systems and methods for creative collaboration among multiple persons have shortcomings.

### SUMMARY OF THE INVENTION

One or more aspects of the present invention include one or more features described herein.

### Collaboration Hub

Systems, apparatuses, and methods are provided for a collaboration hub, such as, preferably, for example, a network-based (e.g., Internet-based) destination, such as, preferably, for example, a website. Preferably, users of the collaboration hub (e.g., users of the website) are able to contribute (e.g., post) content and view content contributed (e.g., posted) by other users.

The present invention contemplates providing and/or enabling the described features using any communication method. Communication methods contemplated by the present invention include, but are not limited to, website presentations, website submissions, blog presentations, blog entries, text messaging, chat messaging, short message service (SMS) messaging, electronic mail, gestures, audio, images, and video.

Preferably, users of the present invention are able to submit content in association with an indication as to the purpose (or other characteristic) of the content, and the content is handled in accordance with such indications.

### Posting with Specific Reference

Preferably, users are able to post content with specific reference to (e.g., depending from and/or identifying and/or indicating an association with, for the purpose of building upon, adding to, expanding upon, further developing, and/or the like) previously posted content (whether such previously posted content was posted by that user or another user).

It should be understood that a content posting having a “specific reference to” (as that phrase is being used herein in connection with the present invention) an earlier content posting can in some embodiments be similar to a discussion board posting being submitted in reply to an earlier discussion board posting, in the respect that the reply posting specifically references the posting being replied to, and is not being submitted in reply to any other discussion board posting, and accordingly does not specifically reference any other discussion board posting. It should be understood that in a discussion board context, the relationship in this regard between the reply posting and the posting being replied to is established by the user definitively selecting the posting being replied to as the posting to which the user wishes to reply (e.g., by clicking on a “reply” button associated with the posting to which the user wishes to reply). Although the content postings of the present invention are not “replies” to other content postings, but instead are being posted to build upon (or, e.g., add to, expand upon, further develop, and/or the like) previous content postings to establish one or more creative works, the mechanism of association of replies to earlier comments in a discussion board context is an example of a mechanism that can be used in some embodiments of the present invention to establish specific reference relationships between content postings.

### Content Organization

Preferably, content postings that are related to one another based on such specific references are organized in accordance with such specific reference relationships to establish a tree-like content structure in which the initial content posting is like the trunk of the tree-like structure (in that it does not specifically reference (e.g., depend from) any earlier content posting), and later content postings are like branches of the tree-like structure (in that they specifically reference (e.g., depend from) either the trunk or another branch).

Accordingly, for ease of explanation only and not for purposes of limitation, each such content structure shall be referred to herein as a “creative work tree”, with (1) the initial content posting of the structure being referred to herein as the “trunk” of the creative work tree, (2) later content postings of the structure being referred to herein as “branches” of the creative work tree, (3) branches having no depending branches being referred to herein as “outer branches”, and (4) a continuous path leading from the trunk to a specified outer branch being referred to herein as a “path” of the creative work tree.

It should be understood that while a tree-with-branches description of the content organization and/or structure is being used for ease of explanation, the present invention contemplates any and all additional and/or alternative content structures that support the features of the present invention. Examples of content structures of the present invention include, but are not limited to, one or more of the following: (1) a branched organization (e.g., similar to a tree having one or more branches), (2) a threaded organization (e.g., similar to a discussion board's comments and replies organization), and/or (3) a hierarchical dependency organization (e.g., similar to an outline of a presentation).

Preferably, users are able to view content postings according to such specific reference relationships. Preferably, such organization of content postings enables content postings to be viewed such that for each content posting, users can view the content posting in association with the earlier content posting that the content posting specifically references (e.g., depends from), and in association with later content postings that specifically reference (e.g., depend from) the content posting.

Preferably, the creative work tree can be navigated by the users of the collaboration hub. Preferably, the means for navigating the creative work tree enables the users to click from one or more content postings to one or more other, related, content postings. Means for navigating the creative work tree preferably include, but are not limited to, the following (as examples only): (1) the manner in which a support forum (having posted problems and submitted assistance for such problems), and (2) the manner in which a discussion board (e.g., having comments and replies to comments) can be navigated.

Preferably, using features of the present invention, users of the collaboration hub are able to vote for and/or otherwise indicate preferences for, creative work trees and or paths of creative work trees.

### Collaboration Features

Preferably, the present invention includes features for encouraging collaboration. Preferably, such collaboration encouragement features include one or more of the following (as examples only): (1) features designed to prevent a single author and/or a limited number of authors from generating all of the content of a creative work, and/or (2) features designed to enable the development of multiple creative works that are related to one another in that they share one or more common content bases.

Preferably with regard to such collaboration encouragement features, and more particularly with regard to features designed to prevent a single author and/or a limited number of authors from generating all of the content of a creative work, in some embodiments, the content of each content posting is limited in one or more aspects. Preferably, such limitations include one or more of the following (as examples only): (1) the number of alphanumeric characters in the content posting (e.g., each content posting cannot exceed 200 alphanumeric characters, or, e.g., each content posting cannot exceed 500 alphanumeric characters), (2) the number of words in the content posting (e.g., each content posting cannot exceed 50 words, or, e.g., each content posting cannot exceed 1 word), and/or (3) the duration of the content posting (e.g., for audio and/or video content) (e.g., an audio or video content posting cannot be longer in duration than 30 seconds, or, e.g., an audio or video content posting cannot be longer in duration than 10 seconds).

Further preferably with regard to such collaboration encouragement features, and more particularly with regard to features designed to enable the development of multiple creative works that are related to one another in that they share one or more common content bases, in some embodiments, permission to post content is governed by one or more rules. Preferably, such rules include one or more of the following (as examples only): (1) users may post content to a creative work tree only a limited number of times (e.g., users are not permitted to post content to a creative work tree more than 5 times, or, e.g., users are not permitted to post content to a creative work tree more than 1 time), (2) users may post content to a path of a creative work tree only a limited number of times (e.g., users are not permitted to post content to a path of a creative work tree more than 10 times, or, e.g., users are not permitted to post content to a path of a creative work tree more than 1 time), (3) a user may post content in specific reference to (e.g., depending from) an earlier content posting only if the user did not post the earlier content posting (e.g., a user may create a branch of the creative work tree only if the user did not create the branch (or trunk) from which the contemplated branch would depend), and/or (4) a user may post content to a creative work tree only if the user has been recognized by the collaboration hub as historically posting content that is meaningful to the collaboration hub community (e.g., the user is highly rated by the collaboration hub community as being a valued content poster).

### BRIEF DESCRIPTION OF THE DRAWINGS

FIG. 1 illustrates a creative work tree in accordance with one or more aspects of the invention.

FIG. 2 illustrates the creative work of FIG. 1, further developed, in accordance with one or more aspects of the invention.

FIG. 3 illustrates a path of the creative work tree of FIGS. 1 and 2, presented in continuous format, in accordance with one or more aspects of the invention.

### DETAILED DESCRIPTION OF PREFERRED EMBODIMENTS

Preferred embodiments of the present invention will now be described in detail.

In a preferred embodiment of the present invention, a collaboration hub is provided as a website. Users of the website are enabled to post content and view content posted by other users. Each user is also able to post content in specific reference to (e.g., depending from) his or her own content postings. Each user is also able to post content in specific reference to (e.g., depending from) content postings of other users. The content postings are organized such that content postings that are related to one another according to such specific reference relationships are viewable according to such specific reference relationships.

For example, a user (referred to for this example as the “originating author”) may start a content posting collection (referred to for this example as the “creative work tree”) by submitting a content posting (referred to for this example as the “trunk”) that does not specifically reference an earlier content posting. The trunk is viewable by all users. Any user can start a branch from the trunk by submitting a content posting that specifically references the trunk. One or more branches (referred to for this example as “first level branches”) can be started from the original content posting.

Each of the first level branches is viewable by all users. Any user can start a branch from a first level branch by submitting a content posting that specifically references the first level branch. One or more such branches (referred to for this example as “second level branches”) can be started from the first level branch.

It should be understood that third, fourth, fifth, and higher branch levels can be generated in accordance with the present invention in this manner. Accordingly, preferably, a plurality of branches at a plurality of different branch levels can be generated by users submitting content postings that specifically reference other content postings, such that the creative work tree is established.

More specifically, with regard to the specific referencing feature, preferably provided in association with (e.g., visually near) each content posting (referred to for this example as a “target content posting”) is presented a selector (e.g., a graphical user interface button) that indicates (e.g., by a label stating, such as, for example, “Add to this Thread” or, for example, “Add a Branch”) to users that if the selector is selected (e.g., the button is clicked), the user will be able to post content in specific reference to the target content posting. For example, if a user wishes to build upon, add to, expand upon, and/or further develop the content of the target content posting, the user can select the selector (e.g., click the button) and be presented with a content posting opportunity, such that if the user posts content by way of that opportunity, the content posted by the user will be organized in specific reference to the target content posting.

Accordingly, preferably, a user can start the development of a creative work, such as, for example, a written work (e.g., story, poem, lyrics, verses, screenplay, stage play, sheet music, cartoon, research project, news report), an audio work (e.g., audible story, audible musical piece, audible spoken word project, audible noise project), a visual work (e.g., visual story, animation, movie), and/or an audiovisual work (e.g., visual story with audio, animation with audio, movie with audio, music video, musical).

Further preferably, the users (including the originating author) can, using the present invention, author aspects of the creative work, take the work in various directions, and/or create various derivations of the creative work, by submitting content posts with specific reference to earlier content posts of the creative work tree. In this manner, multiple authors can contribute to the creative work. Preferably, all of the content postings and specific reference relationships are saved and viewable, preferably in accordance with the specific reference relationships, so that the points at which the development of the creative work diverges to create the different paths of the creative work tree are preserved.

Further preferably, collaboration tools such as, for example, the above mentioned collaboration tools, can be used to (1) increase the likelihood that many authors (versus a single author or a small number of authors) will contribute to each creative work, and/or (2) establish and preserve frequent decision (or, e.g., direction) points during the development of each creative work (points from which the direction of the development of the work is decided) and enable multiple directions of development from such points by multiple authors. Preferably, in some embodiments, the parameters of the collaboration tools can be established by users. Preferably, in some embodiments, the parameters of the collaboration tools are established by the user who creates the trunk of the creative work tree.

### Specific Example

Now will be set forth a specific example of an embodiment of the present invention and a demonstrative use thereof. It should be understood that this example is an example only and not to be construed as limiting the scope of the present invention.

In this example, in a preferred embodiment of the present invention having one or more of the above described features, a user (e.g., a first user, or “U1”) of the website desires to author a story.

The first user selects a website-provided option to start a trunk (e.g., clicks a button labeled “Start a New Story”), and is presented with a content submission device (e.g., a web-based form). The first user fills the content submission device with the trunk content (e.g., types the beginning of the story into the web-based form). In this embodiment, to facilitate collaboration, content postings are limited to 200 alphanumeric characters. Accordingly, each user is permitted to type no more than 200 alphanumeric characters. In this example, the first user types 190 characters into the web-based form and submits the content. The content is posted as the trunk and is viewable by all other users. The trunk posting will be designated to for this example as “T”.

(It should be understood that in some embodiments, groups of users can be established such that only certain groups of users are permitted to contribute to a particular creative work tree.)

The first user decides that he or she wants to continue the story from the trunk. The first user selects a website-provided option to submit content with specific reference to the trunk (e.g., clicks a button labeled “Continue this Story from Here” adjacent the trunk), and is presented with a content submission device (e.g., a web-based form). The first user fills the content submission device with the new branch content (e.g., types the continuation of the story into the web-based form). The first user types 150 characters into the web-based form and submits the content. The content is posted as a first first level branch of the trunk and is viewable by all other users. This first first level branch posting will be designated for this example as “T-1”, indicating that it is the first first level branch off the trunk (wherein the “T” refers to the fact that the branch descends directly from the trunk, and the “1” refers to the instance number).

(It should be understood that the character number limitation ensures that if another user has an idea as to where the story should go after the trunk (or branch), that other user has the opportunity to submit content in accordance with that idea with specific reference to the trunk (or branch), for all users to view. If the limitation were not present, the author of a trunk (or branch) could develop the story to a greater length without interruption, such that the direction of the story is less malleable, and the decision points within the trunk (or branch) are not accessible as direction points to other users.).

(It should further be understood that one or more other types of posting limitations, such as, for example, those discussed elsewhere within this description of the present invention, can additionally or alternatively be used to modify the frequency and/or prevalence of decision points.)

Further to the present example, a second user (“U2”) views the trunk (T) and the first first level branch (T-1) and decides that he or she wants to continue the story from the trunk instead of from the first first level branch. The second user selects a website-provided option to submit content with specific reference to the trunk (e.g., clicks a button labeled “Continue this Story from Here” adjacent the trunk), and is presented with a content submission device (e.g., a web-based form). The second user fills the content submission device with the new branch content (e.g., types his or her continuation of the story into the web-based form). The second user types 175 characters into the web-based form and submits the content. The content is posted as a second first level branch of the trunk and is viewable by all other users. This second first level branch posting will be designated for this example as “T-2”, indicating that it is the second first level branch off the trunk. The trunk and both first level branches are viewable by all users. For example, users viewing the trunk are preferably able to view both first level branches in connection with trunk, and follow the two variations of the story.

Other users view the creative work tree and in accordance with the above described mechanisms, a third user (“U3”) posts a first second level branch from the first first level branch, accordingly designated as “T-1-1”, a fourth user (“U4”) posts a third first level branch from the trunk, accordingly designated as “T-3”, the first user posts a first second level branch from the second first level branch, designated as “T-2-1”, and the second user posts a second second level branch from the second first level branch, designated as “T-2-2”.

(It should be noted that the designations used for example in this embodiment are for ease in understanding the structure of the creative work tree, but not to limit the scope of the present invention.)

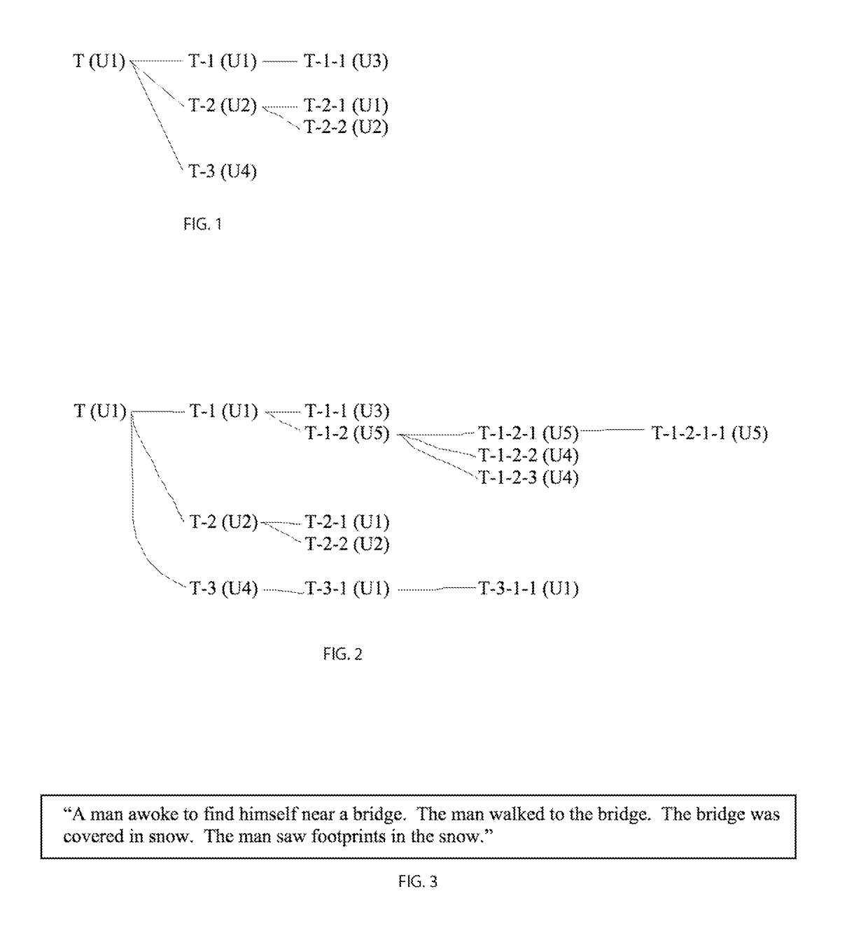

At this point in the example, the creative work tree can be represented as shown in FIG. 1.

The development of the creative work tree continues with these and other users until the creative work tree can be represented as shown in FIG. 2.

As can be seen from the representation, U5 had some storyline ideas stemming from T-1 that span multiple consecutive decision points, U4 wanted to continue the story from T-1-2 and in fact had two different direction ideas (T-1-2-2 and T-1-2-3) for the story from that branch. Meanwhile, U1 liked U4's contribution in T-3 and so built on that branch for two consecutive branches (T-3-1 and T-3-1-1).

Development of the creative work tree can continue in like manner such that these and/or additional users can create multiple versions of a story (multiple paths of the creative work tree), each of which can be followed from and/or through the various decision points.

### Viewing in Continuous Format

In some embodiments, users are able to view a selected path in a continuous format, such that the path reads as an uninterrupted work. Preferably, the desired path elements can be selected by the user. Using the above example to illustrate this, if a user wanted to read as an uninterrupted work the path represented by (T)/(T-1)/(T-1-2)/(T-1-2-3), the content from these postings can be reformatted to be presented without showing other content postings and/or as a continuous work.

Presentation in this manner may be desirable for a user who wants to read a particular path easily and without distraction, and/or who wants to follow the development of a particular path.

For example, if the content of “T” is “A man awoke to find himself near a bridge.”, and the content of T-1 is “The man walked to the bridge.”, and the content of T-1-2 is “The bridge was covered in snow.”, and the content of T-1-2-3” is “The man saw footprints in the snow.”, then the reformatting and presentation in this manner could be presented as in FIG. 3, without other content postings in the creative work tree.

### Another Preferred Embodiment

In another preferred embodiment of the present invention, a collaboration hub is provided as a messaging center. Users of the messaging center are enabled to post content by messaging service (e.g., text message, SMS message, or electronic mail) and view content posted by other users using the messaging service.

Preferably, users of the collaboration hub are able to be associated with (e.g., subscribe to, or follow) specific creative work trees, branches, paths, other users, and/or other shared aspects of the content. For example, if a user is associated with a specific creative work tree, the user receives and/or submits messages related to that specific creative work tree. Or, for example, if a user is associated with a specific other user, the user receives messages submitted by that other user and/or messages related to content associated with that other user. Preferably, the user is able to choose the association and/or the extent and other aspects of the association.

For example, if a user desires to follow a creative work tree, the user may opt to receive posts related to that creative work tree. Further preferably, when receiving the latest proposed additions to the creative work tree, the user is able to indicate the user's liking or disliking of the additions, and/or is able to choose which of the new branches the user likes most and/or wishes to follow.

In some embodiments, to indicate whether you are starting a new thread, adding to an existing thread, or sending a comment, a user preferably is able to preface the message with a specific character or specific characters. For example, to start a thread, the message would be preceded by, e.g., a “*” and/or, e.g., “000000”. Or, for example, to add to an existing thread, the message would be preceded by, e.g., a “&” and/or, e.g., a unique identifier associated with the branch being specifically referenced (e.g., “014532”). Or, for example, if commenting on a specific branch (as opposed to adding to the thread), the message would be preceded by a “/” and the unique identifier associated with the branch.

### Yet Another Preferred Embodiment

The computer code attached hereto as “CODE LISTING”, is hereby incorporated by reference herein, and sets forth systems, devices, and methods of another preferred embodiment of the present invention. For example, executing the computer code implements systems, devices, and methods of the present invention, including but not limited to generating interface views and elements in accordance with aspects of the present invention. In this embodiment, each user is not permitted to add a branch directly to a branch (or trunk) the user has authored.

What is claimed is:

1. A system for establishing a plurality of creative works, each creative work being defined by a respective set of content postings, the content postings in each set being organized in the set in accordance with specific reference relationships established between later contributed content postings and earlier contributed content postings, the system comprising:
a website enabling users of the website to contribute the content postings, each content posting being a later contributed content posting with respect to any contributed earlier, and being an earlier contributed content posting with respect to any contributed later,
the website enabling, in connection with each later contributed content posting, a specific reference to be made to a respective earlier contributed content posting,
each specific reference defining a specific reference relationship between the later contributed content posting and the earlier contributed content posting, each specific reference relationship establishing that the later contributed content posting builds upon the earlier contributed content posting,
the website including one or more features for encouraging collaboration by the users, the encouragement features including preventing, with respect to each user, the establishment of a specific reference relationship between any later contributed content posting contributed by the user and any earlier contributed content posting contributed by the user.
